(19) United States
(12) Patent Application Publication
(10) Pub. No.: US 2023/0141579 A1
(43) Pub. Date: May 11, 2023

(54) VEHICLE LAUNCH MODE PRESSURE REMOVAL IN HYDRAULIC BRAKING SYSTEM

(71) Applicant: Continental Automotive Systems, Inc., Auburn Hills, MI (US)

(72) Inventors: Antonio Minna, JR., Sterling Heights, MI (US); Richard Davis, Orion, MI (US)

(73) Assignee: Continental Automotive Systems, Inc., Auburn Hills, MI (US)

(21) Appl. No.: 17/453,668

(22) Filed: Nov. 5, 2021

(51) Int. Cl. B60T 8/175; B60T 8/32; B60W 30/18

(52) U.S. Cl. CPC B60T 8/175; B60T 8/3205; B60W 30/18027; B60W 2540/12; B60W 2540/10; B60W 2510/0638; B60W 2510/182; B60W 2710/0644; B60W 2710/182

(57) ABSTRACT

A system for controlling launch of a vehicle includes a pressure-providing device constructed and arranged to deliver a pressure medium to wheel brakes of the vehicle. A pressure chamber is fluidly connected with the pressure-providing device and is configured for containing the pressure medium. An electronic control unit has a processor circuit that is constructed and arranged, during a launch mode of the vehicle, to control the pressure-providing device to cause fluid from the wheel brakes to be directed to the pressure chamber so as to release the pressure medium from the wheel brakes, permitting launch of the vehicle.

### FIELD

The invention relates to a system for controlling launch of a vehicle and, in particular, to a system that employs a vehicle electronic braking system to quickly release brake pressure in a launch mode.

### BACKGROUND

### 1. Field

Launch control is an advanced driving assistance system (ADAS) currently employed in sport cars and other performance-oriented vehicles that helps facilitate quick acceleration from a standing start and thus reduce 0 to 60 mph times and or drag racing times. In a drag race, getting off the line faster than your competition is as important as the power of the engine. Wheel spin may delay the time to get off the line since the vehicle may not be gripping the road during such wheel spin. Launch control minimizes wheel spin (and hop) and also helps avoid over-revving the engine and overheating the transmission.

### 2. Description of Related Art

Conventional launch control is typically associated with electronic braking systems that use hydraulic brakes. Current launch control systems actuate one or more solenoid valves to release hydraulic fluid pressure at the vehicle wheel brakes to initiate the launch.

There is a need in a system for controlling launch of a vehicle to reduce the time to remove pressure at the wheel brakes during the launch mode.

### SUMMARY

An objective of one or more embodiments is to fulfill the need referred to above. In accordance with the principles of a present embodiment, this objective is obtained by providing a system for controlling launch of a vehicle that includes a pressure-providing device constructed and arranged to deliver a pressure medium to wheel brakes of the vehicle. A pressure chamber is fluidly connected with the pressure-providing device and is configured for containing the pressure medium. An electronic control unit has a processor circuit that is constructed and arranged, during a launch mode of the vehicle, to control the pressure-providing device to cause fluid from the wheel brakes to be directed to the pressure chamber so as to release the pressure medium from the wheel brakes, permitting launch of the vehicle.

In accordance with another aspect of a disclosed embodiment, a method for controlling wheel brakes during a launch of a vehicle includes, upon initiation of a launch mode of a vehicle, causing fluid pressure to be held at wheel brakes of the vehicle, and after determining that a vehicle operating parameter threshold is reached, controlling, via a processor circuit, a brake pressure-providing device to release the fluid pressure held at the wheel brakes to permit launch of the vehicle.

Other objectives, features and characteristics of the embodiments, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The embodiments will be better understood from the following detailed description of the preferred embodiments thereof, taken in conjunction with the accompanying drawings, wherein like reference numerals refer to like parts, in which:

FIG. 1 is a schematic view of a system for controlling launch of a vehicle in accordance with an embodiment.

FIG. 2 is a flowchart of method steps of controlling wheel brakes of the embodiments.

FIG. 3 is a schematic view of a system for controlling launch of a vehicle in accordance with a second embodiment.

### DETAILED DESCRIPTION OF EMBODIMENTS

The following detailed description includes references to the accompanying drawings, which form a part of the detailed description. The drawings show, by way of illustration, specific embodiments in which the apparatus may be practiced. These embodiments, which are also referred to herein as “examples” or “options,” are described in enough detail to enable those skilled in the art to practice the present embodiments. The embodiments may be combined, other embodiments may be utilized, or structural or logical changes may be made without departing from the scope of the disclosure. The following detailed description is, therefore, not to be taken in a limiting sense but defined by the appended claims and their legal equivalents.

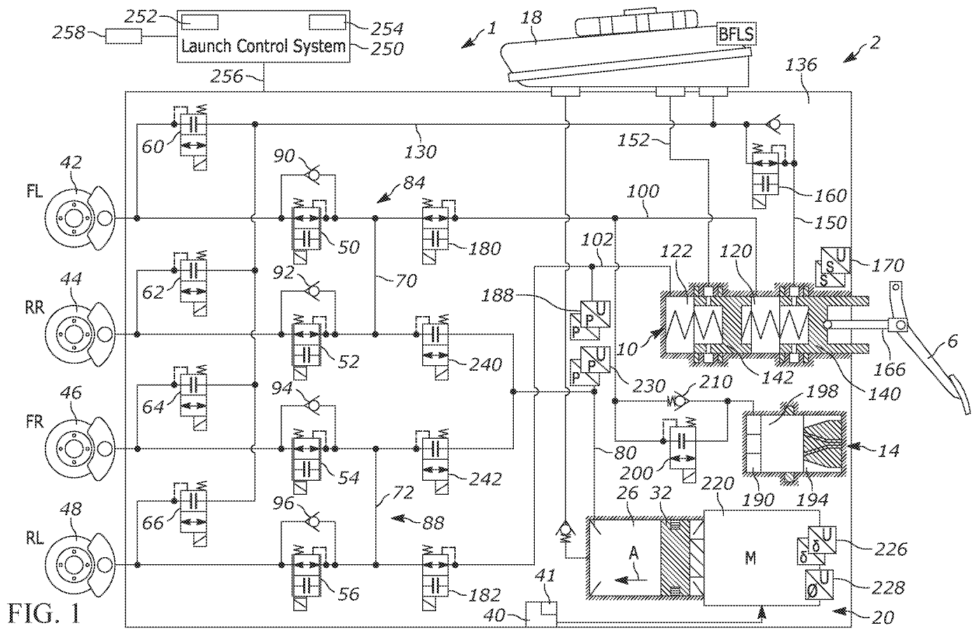

Referring to FIG. 1, a system for controlling launch of a vehicle is shown generally indicated at 1 in accordance with an embodiment. The system 1 includes an electronic braking system shown generally indicated at 2 and a launch control system 250 associated there-with. The braking system 2 can be of the type disclosed in Patent Application Publication US 2020/0001846 A1, the contents of which is hereby incorporated by reference. The braking system 2 comprises a master brake cylinder 10 actuated by means of an actuation pedal or brake pedal 6, a simulation device 14 cooperating with the master brake cylinder 10, a fluid pressure reservoir 18 assigned to the master brake cylinder 10 and standing under atmospheric pressure, an electrically controllable pressure-providing device 20 formed by a cylinder-piston arrangement with a hydraulic pressure chamber 26, the piston 32 of which can be displaced by an electromechanical actuator, an electrically controllable pressure-modulation device for setting wheel-individual brake pressures, and an electronic control unit (ECU) 40 for controlling the electrically operated components.

The pressure-modulation device comprises, for example, hydraulically actuatable wheel brakes 42, 44, 46, 48, and for each actuatable wheel brake 42 to 48 a respective inlet valve 50, 52, 54, 56 and an outlet valve 60, 62, 64, 66 connected together hydraulically in pairs via central connections and connected to the wheel brakes 42 to 48. The input connections of the inlet valves 50 to 56 are supplied with pressures by means of brake circuit supply lines 70, 72; in a “brake-by-wire” operating mode, these pressures are derived from a system pressure present in a system pressure line 80 connected to the pressure chamber 26 of the pressure-providing device 20, and corresponds to the pressure provided by the pressure-providing device. Here, the brakes 42, 44 are hydraulically connected to a first brake circuit 84, and the brakes 46, 48 are hydraulically connected to a second brake circuit 88.

A respective check valve 90, 92, 94, 96 which opens towards the brake circuit supply lines 70, 72 is connected in parallel to each inlet valve 50 to 56. In fallback operating mode, the brake circuit supply lines 70, 72 are loaded with the pressures of the brake medium from pressure chambers 120, 122 of the master brake cylinder 10 via hydraulic lines 100, 102. The output connections of the outlet valves 60 to 66 are connected to the fluid pressure reservoir 18 via a return line 130.

The master brake cylinder 10 has, in a housing 136, two pistons 140, 142 arranged in series and which delimit the hydraulic pressure chambers 120, 122. The pressure chambers 120, 122 are connected on one side to the pressure medium reservoir 18 via radial bores formed in the pistons 140, 42 and via corresponding pressure-balancing lines 150, 152, wherein the connections can be shut off by a relative movement of the pistons 140, 142 in the housing 136. On the other side, the pressure chambers 120, 122 are connected to the above-mentioned brake circuit supply lines 70, 72 by means of hydraulic lines 100, 102.

A normally open valve 160 is situated in the pressure-balancing line 150. The pressure chambers 120, 122 contain restoring springs, which position the pistons 140, 142 in a starting position when the master brake cylinder 10 is not actuated. A piston rod 166 couples the pivot movement of the brake pedal 6 due to pedal actuation to the translation movement of the first master brake cylinder piston 140 or primary piston, the actuation travel of which is detected by a travel sensor 170, configured in redundant fashion. In this way, the corresponding piston travel signal is a measure of the brake pedal actuation angle. It represents a braking request by the vehicle driver.

A separating valve 180, 182 configured as an electrically actuatable, normally open, 2/2-way directional control valve is arranged in each line portion 100, 102 connected to the pressure chambers 120, 122. The separating valves 180, 182 can shut off the hydraulic connection between the pressure chambers 120, 122 of the master brake cylinder 10 and the brake circuit supply lines 70, 72. A pressure sensor 188 connected to the line portion 102 detects the pressure built up in the pressure chamber 122 by movement of the second piston 142.

The simulation device 14 can be hydraulically coupled to the master brake cylinder 10 and substantially comprises for example a simulator chamber 190, a simulator spring chamber 194, and a simulator piston 198 separating the two chambers 190, 194 from each other. This simulator piston 198 is supported on the housing 136 by an elastic element (e.g. a spring) arranged in the simulator spring chamber 194 and advantageously preloaded. The simulator chamber 190 is connectable to the first pressure chamber 120 of the master brake cylinder 10 by means of an electrically actuatable simulator valve 200. When a pedal force is input and simulator valve 200 is open, pressure medium flows from the master brake cylinder pressure chamber 120 into the simulator chamber 190. A check valve 210 arranged hydraulically antiparallel to the simulator valve 200 allows the pressure medium to flow back from the simulator chamber 190 to the master brake cylinder pressure chamber 120 largely unhindered, irrespective of the switching state of the simulator valve 200. Other embodiments and connections of the simulation device to the master brake cylinder 10 are conceivable.

The electrically controllable brake pressure-providing device 20, providing brake system pressure, is configured as a hydraulic cylinder-piston arrangement or a single circuit electrohydraulic actuator, in which the pressure piston 32 delimiting the pressure chamber 26 can be actuated by an electrically controlled motor 220 with the interposition of a rotation-translation gear mechanism (also indicated diagrammatically) configured as a ball screw drive (KGT). A rotor position sensor 226 serves to detect the rotor position of the electric motor 220. In addition, a temperature sensor 228 may be used for sensing the temperature of the motor 220 winding.

The actuator pressure generated by the effect of the force of the piston 32, moving in direction A, on the pressure medium enclosed in the pressure chamber 26 is fed into the system pressure line 80 and detected by means of a pressure sensor 230, which is of redundant design. When the pressure switching valves 240, 242 are opened, the pressure medium actuates the wheel brakes 42 to 48. A wheel brake pressure is built up and dissipated for all wheel brakes 42 to 48 by the forward and return movement of the piston 32, when the pressure actuation valves 240, 242 are opened, in normal braking in brake-by-wire operating mode.

When the pressure dissipates, the pressure medium (fluid) previously displaced from the pressure chamber 26 into the wheel brakes 42 to 48 returns to the pressure chamber 26 on the same route. In contrast, when braking with different wheel brake pressures for each individual wheel which are regulated using the inlet and outlet valves 50 to 56, 60 to 66 (e.g. on ABS braking), the part of the pressure medium discharged via the outlet valves 60 to 66 flows into the pressure medium reservoir 18 and is therefore no longer available initially to the pressure-providing device 20 for actuating the wheel brakes 42 to 48.

In the embodiment, the electronic braking system 2 is co-operable with a conventional vehicle launch control system 250. The launch control system 250 includes an actuator 252, such as an actuatable push-button in the vehicle cockpit, to initiate a launch mode of the vehicle. The launch control system 250 has a control unit 254 that is electrically connected with sensors such as a sensor associated with the brake pedal 6, with an accelerator pedal 258, with the transmission to control the transmission, and with a speed sensor to measure speed of the vehicle's output shaft. In the embodiment, after actuation of the actuator 252, the control unit 254 is configured to send an electrical signal 256 to the braking system 2 and thus to the ECU 40 indicating that the present condition requires that the rate of pressure decrease at the wheel brakes be greater than achievable by the braking system 2 in normal operation (e.g., when fluid normally returns to the reservoir 18 as described above).

As noted above in the Background section, in conventional launch control and braking systems, the electric signal sent from the launch control system to the braking system instructs the ECU of the braking system to actuate at least one solenoid valve, such as valves 240 and 242 in FIG. 1, to unlock the wheel brakes and permit vehicle launch. However, actuating valve 240 and 242 may not be sufficient to quickly remove brake pressure from the braking system 10 and thus may hinder the launch. Thus, in accordance with an embodiment of FIG. 1, in the launch mode when the brake pedal 6 is first depressed and then released and while the accelerator pedal 258 is depressed, the signal 256 is received at the ECU 40 and a processor circuit 41 thereof signals the motor 220 to move the piston or movable member 32 in a direction opposite of direction A to quickly cause the hydraulic fluid at, at least certain of the wheel brakes 42, 44, 46 and 48, to be directed into the pressure chamber 26. When the motor 220 is controlled to move the piston 32, valve 240 and 242 can also be actuated to aid in fluid at certain of the wheel brakes to return to the pressure chamber 26. Thus, the time required for pressure to decrease at the wheel brakes is greatly reduced by use of the motor 220 and piston 32.

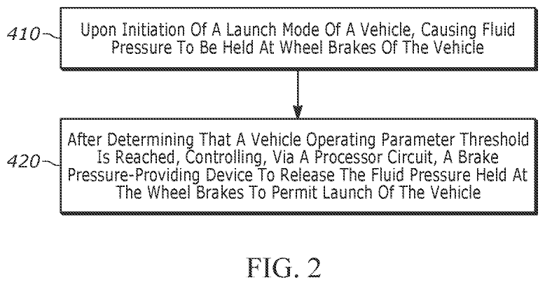

With reference to FIG. 2, a method for controlling wheel brakes during a launch of a vehicle includes in step 410, upon initiation of a launch mode of a vehicle, causing fluid pressure to be held at certain of the wheel brakes 42, 44, 46, 48. In step 420, after determining that a vehicle operating parameter threshold is reached (explained further below), the processor circuit 41 controls the brake pressure-providing device 20 to release the fluid pressure held at the wheel brakes to permit launch of the vehicle.

A detailed description of controlling a launch mode of a vehicle with the system 1 includes the following steps:
a) Initiate launch mode by engaging actuator 252 in vehicle,
b) Press on the brake pedal 6 and hold, causing at least certain of the wheel brakes 42, 44, 46, 48 to receive and hold fluid pressure at wheel brakes,
c) Release the brake pedal 6 while braking system continues to hold fluid pressure at wheel brakes,
d) Press on accelerator pedal 258 until kick down and hold,
e) Controller 254 regulates the rpm and starting speed, and once desired engine rpm (e.g., vehicle operating parameter threshold) is reached, the processor circuit 41 automatically controls the pressure-providing device in the form of the motor 220 and piston 32, with the motor moving the piston 32 to cause release of the fluid pressure from the engaged wheel brakes,
f) Controller 254 causes the clutch/gear to engage, thereby causing launch of the vehicle.

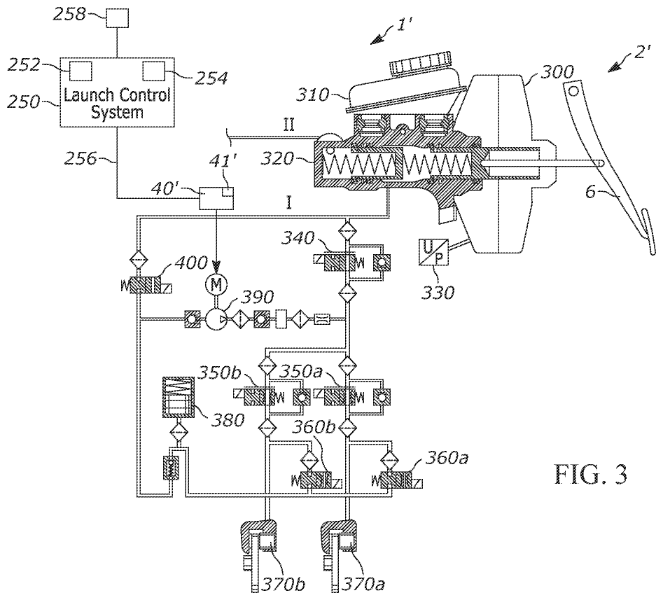

With reference to FIG. 3, a system for controlling launch of a vehicle is show generally indicated at 1′ in accordance with a second embodiment. The system 1′ includes an electronic braking system 2′ and the launch control system 250. The braking system 2′ can be of the type disclosed in Patent Application Publication US 2015/0298670 A1, the contents of which is hereby incorporated by reference. The brake pedal 6 actuated by the driver acts on a (tandem) master brake cylinder 320, via a pressure rod with superimposition of an auxiliary force built up by an underpressure brake booster 300, which (tandem) master brake cylinder 320 is connected in the inactivated state to a pressureless brake fluid reservoir container 310. The absolute pressure in the underpressure chamber or the differential pressure with respect to the surroundings can be measured by means of a vacuum sensor or pressure sensor 330. It is therefore possible to check whether sufficient underpressure is present or whether hydraulic assistance is necessary. The brake system has two brake circuits I, II, to each of which two wheel brakes are assigned (in the case of a four-wheeled motor vehicle). In the text which follows, only the brake circuit I is described. The other brake circuit II is of identical design. The division of the brake circuits, that is to say whether for example in each case a front wheel brake and a rear wheel brake are combined in a brake circuit, is in principle insignificant for the system and method according to the embodiment.

The master brake cylinder 320 is fluidly connected via brake lines to the wheel brakes 370a, 370b, wherein the first wheel brake 370a can be disconnected from the master brake cylinder 320 by closing a first inlet valve 350a, and the second wheel brake 370b can be disconnected from the master brake cylinder 320 by means of a second inlet valve 350b. The pressure in the first and second wheel brakes can be reduced by opening an outlet valve 360a or 360b in that brake fluid is diverted into a low pressure chamber or accumulator 380. A hydraulic pump 390, driven by an electrically controlled motor M, permits the low pressure accumulator 380 to be emptied. In addition, the brake system has a solenoid valve 340, designated as an isolating valve, that can be actuated in an analogous fashion. Valve 340 is open in a currentless state and is arranged between the outlet side of the hydraulic pump 390 and the master brake cylinder 320. The suction side of the hydraulic pump 390 is connected to the low pressure accumulator 380 and can be connected to the master brake cylinder 320 via a solenoid valve 400 as an electronic switching valve and is closed in a currentless state. The motor and pump 390 can be considered as a brake pressure-providing device since the motor M can be activated in such a way that the pump 390 can build up a brake pressure on the high-pressure side by drawing in brake fluid on the intake side.

Wheel speed sensors, which are connected to an electronic control unit (ECU) 40′ with processor circuit 41′, are expediently arranged on each wheel of the motor vehicle. The ECU 40′ is configured to control the electrically controlled components of the system 2, including motor M. If the wheel speed of a wheel during braking decreases strongly, a brake slip control process or antilock brake control process can take place in that the corresponding inlet valve is closed and the pressure in the wheel brake, and therefore the braking force, are reduced by opening the corresponding outlet valve. The brake slip control process can be carried out by means of methods which are known per se and in which pressure buildup phases, pressure holding phases and pressure reduction phases repeat cyclically.

The ECU 40′ and thus the electronic braking system 2′ is co-operable with a conventional vehicle launch control system 250. As noted above, the launch control system 250 includes an actuator 252, such as a push-button in the vehicle cockpit, to initiate a launch mode of the vehicle. The launch control system 250 has a control unit 254 configured to send an electrical signal 256 to the ECU 40′ indicating that the present condition requires that the rate of pressure decrease be greater than achievable by the braking system 2 in normal operation (e.g., when fluid normally returns to the reservoir 310).

In accordance with the second embodiment, in the launch mode when the brake pedal 6 is first depressed and then released while the accelerator pedal 258 is depressed, the signal 256 is received at the ECU 40′ and a processor circuit 41′ thereof instructs the motor M to operate the pump or movable member 390 in a suction mode to quickly cause the hydraulic fluid at the wheel brakes 370a, 370b, to be directed into the pressure chamber or accumulator 380. The processor circuit 41′ of the ECU can also open valve 360a, 360b to cause brake fluid from the wheel brakes to return to the accumulator 380. Thus, the time required for pressure to decrease at the wheel brakes is greatly reduced due to use of the motor M and suction pump 390.

As noted above, FIG. 2 shows a flowchart of a method for controlling wheel brakes during a launch of a vehicle. The method is applicable to the system 1′ as well. Thus, in step 410, upon initiation of a launch mode of a vehicle, fluid pressure is caused to be held at certain of the wheel brakes 370a, 370b. In step 420, after determining that a vehicle operating parameter threshold is reached, the processor circuit 41′ controls the brake pressure-providing device (motor M, pump 390) to release the fluid pressure held at the wheel brakes to permit launch of the vehicle.

A more detailed description of controlling a launch mode of a vehicle with the system 1′ (FIG. 3) includes the following steps:
a) Initiate launch mode by engaging actuator 252 in vehicle,
b) Press on the brake pedal 6 and hold, causing at least certain of the wheel brakes 370a, 370b to receive and hold fluid pressure at wheel brakes,
c) Release the brake pedal 6 while braking system continues to hold fluid pressure at wheel brakes,
d) Press on accelerator pedal 258 until kick down and hold,
e) Controller 254 regulates the rpm and starting speed, and once desired engine rpm (e.g., vehicle operating parameter threshold) is reached, the processor circuit 41′ automatically controls pressure-providing device in the form of the motor M and piston pump 390, with the motor M moving the piston pump 390 to cause release of the fluid pressure from the engaged wheel brakes,
f) Controller 254 causes the clutch/gear to engage, thereby causing launch of the vehicle.

Thus, with the launch control systems 1 and 1′, the time required to release brake pressure from the wheel brakes during a launch mode is greatly decreased when compared to conventional systems. Also, the embodiments allow for a calibrated release speed for application specific settings.

The operations and algorithms described herein can be implemented as executable code within the processor circuits 41, 41′ as described, or stored on a standalone computer or machine readable non-transitory tangible storage medium that are completed based on execution of the code by a processor circuit implemented using one or more integrated circuits. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit and implemented using one or more integrated circuits, where execution of executable code stored in an internal memory circuit causes the integrated circuit(s) implementing the processor circuits 41, 41′ to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. A memory circuit can be implemented, for example, using a non-volatile memory such as a programmable read only memory (PROM) or an EPROM, and/or a volatile memory such as a DRAM, etc.

The operations described with respect to any of the Figures can be implemented as executable code stored on a computer or machine readable non-transitory tangible storage medium (i.e., one or more physical storage media such as a floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.). Hence, one or more non-transitory tangible media can be encoded with logic for execution by a machine, and when executed by the machine operable for the operations described herein

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

1. A method for controlling wheel brakes during a launch of a vehicle, the method comprising the steps of:
upon initiation of a launch mode of a vehicle, causing fluid pressure to be held at wheel brakes of the vehicle, and
after determining that a vehicle operating parameter threshold is reached, controlling, via a processor circuit, a brake pressure-providing device to release the fluid pressure held at the wheel brakes to permit launch of the vehicle.

2. The method of claim 1, wherein the pressure-providing device comprises an electrically controllable motor and a movable member configured to be moved by the motor, and wherein the controlling step controls the motor.

3. The method of claim 2, wherein the pressure-providing device comprises a pressure piston, as the movable member, disposed in a pressure chamber, wherein the controlling step includes controlling the motor to move the pressure piston to draw fluid into the pressure chamber and thus release the fluid pressure held at the wheel brakes.

4. The method of claim 2, wherein the pressure-providing device comprises a pump as the movable member, wherein the controlling step includes controlling the motor to move cause the pump to draw fluid into a pressure chamber and thus release the fluid pressure held at the wheel brakes.

5. The method of claim 1, wherein the vehicle operating parameter threshold is engine rpm.

6. A system for controlling launch of a vehicle, the system comprising:
a pressure-providing device constructed and arranged to deliver a pressure medium to wheel brakes of the vehicle,
a pressure chamber fluidly connected with the pressure-providing device and configured for containing the pressure medium, and
an electronic control unit having a processor circuit that is constructed and arranged, during a launch mode of the vehicle, to control the pressure-providing device to cause fluid from the wheel brakes to be directed to the pressure chamber so as to release the pressure medium from the wheel brakes, permitting launch of the vehicle.

7. The system of claim 6, wherein the pressure-providing device comprises an electrically controllable motor and a movable member configured to be moved by the motor.

8. The system of claim 7, wherein the pressure-providing comprises a pressure piston, as the movable member, disposed in the pressure chamber, with the pressure piston being movable by the motor to draw the fluid into the pressure chamber during the launch mode.

9. The system of claim 7, wherein the pressure-providing device comprises a pump as the movable member, wherein the pressure chamber is an accumulator fluidly connected with the pump such that the pump can draw fluid into the accumulator during the launch mode.

10. The system of claim 8, further comprising at least one electrically operated valve between the wheel brakes and the pressure chamber, wherein, during the launch mode, wherein the processor circuit is constructed and arranged to actuate the at least one electrically operated valve when controlling the motor so that fluid at the wheel brakes can be sent through the electrically operated valve to the pressure chamber.

11. The system of claim 8, wherein the processor circuit is constructed and arranged to control the motor to move the piston 1) in a first direction to deliver the pressure medium from the pressure chamber to wheel brakes of the vehicle, and 2) in a direction opposite the first direction during the launch mode.

12. The system of claim 9, further comprising an electrically operated valve fluidly coupled with each wheel brake and with the accumulator, wherein the processor circuit is constructed and arranged to activate each electrically operated valve when controlling the motor so that fluid at the wheel brakes can be sent through electrically operated valves to the accumulator.

13. The system of claim 9, wherein the processor circuit is constructed and arranged to control the motor 1) so that the pump builds up a brake pressure on a high-pressure side thereof by drawing in the pressure medium on an intake side so as to deliver the pressure medium to wheel brakes and, during the launch mode, 2) to operate the pump in a suction mode to draw the pressure medium away from the wheel brakes and into the accumulator.

14. The system of claim 6, further comprising a fluid reservoir, the pressure chamber being fluidly connected with the reservoir.

15. The system of claim 6, further comprising the wheel brakes, a braking system, a brake pedal for causing braking of the vehicle via the braking system, and an accelerator pedal for causing acceleration for the vehicle.

16. The system of claim 15, wherein the processor circuit is constructed arranged, during the launch mode and when the brake pedal is depressed causing the wheel brakes to receive and hold the pressure medium and when the brake pedal is thereafter released while the brake system holds the pressure medium and while the accelerator pedal is depressed, to control the pressure-providing device to direct fluid from the wheel brakes to the pressure chamber.

17. The system of claim 6, further comprising an actuator constructed and arranged to be disposed in an interior of the vehicle for initiating a launch control mode.

18. The system of claim 6, wherein the electronic control unit is constructed and arranged to control a braking system of the vehicle.

19. One or more non-transitory tangible media encoded with logic for execution by a machine and when executed by the machine operable for:
upon initiation of a launch mode of a vehicle that causes fluid pressure to be held at wheel brakes of the vehicle and after determining that a vehicle operating parameter threshold is reached, controlling, by the machine, a brake pressure-providing device to release the fluid pressure held at the wheel brakes to permit launch of the vehicle.

20. The one or more non-transitory tangible media of claim 19, wherein the pressure-providing device comprises an electrically controllable motor and a movable member configured to be moved by the motor, and wherein the controlling step controls the motor.
